(19) United States
(12) Patent Application Publication
(10) Pub. No.: US 2015/0223575 A1
(43) Pub. Date: Aug. 13, 2015

(54) Guitar pick finger ring with removable- guitar pick

(71) Applicant: Gerald Martin Farnum, Las Vegas, NV (US)

(72) Inventor: Gerald Martin Farnum, Las Vegas, NV (US)

(21) Appl. No.: 13/999,303

(22) Filed: Feb. 10, 2014

(51) Int. Cl. A44C 9/00; G10D 3/16

(52) U.S. Cl. CPC A44C 9/0061; G10D 3/163

(57) ABSTRACT

A finger ring for removing yet stably retaining an article commonly known as a guitar pick used for playing a guitar is disclosed.

### SUMMARY OF THE INVENTION

The disclosed invention relates particularly to a finger ring jewelry item that stably yet removably retains an article commonly known as a guitar pick. Musicians often utilize an item such as a plectrum to pick or strum a stringed instrument such as a guitar. When the playing article particularly a small one such as a guitar pick is not attached to the musical instrument itself it can be easily dropped and lost. It is therefore advantageous that the musician has a guitar pick close at hand. This invention affords this advantage quite literally as it is worn on the musicians hand.

### BRIEF DESCRIPTION OF DRAWINGS

FIG. 1: Is a perspective view of the music article jewelry item with a guitar pick installed and being removed.

FIG. 2: Is a perspective view of the invention as it relates to being worn on the musicians hand.

FIG. 3: Is an exploded view of the summary of all the parts of this invention.

FIG. 4: As an enlarged top view illustrating the utilization of prongs with the setting to stably yet remove and retain a guitar pick.

### DETAILED DESCRIPTION OF THE PREFERRED EMBODIMENTS

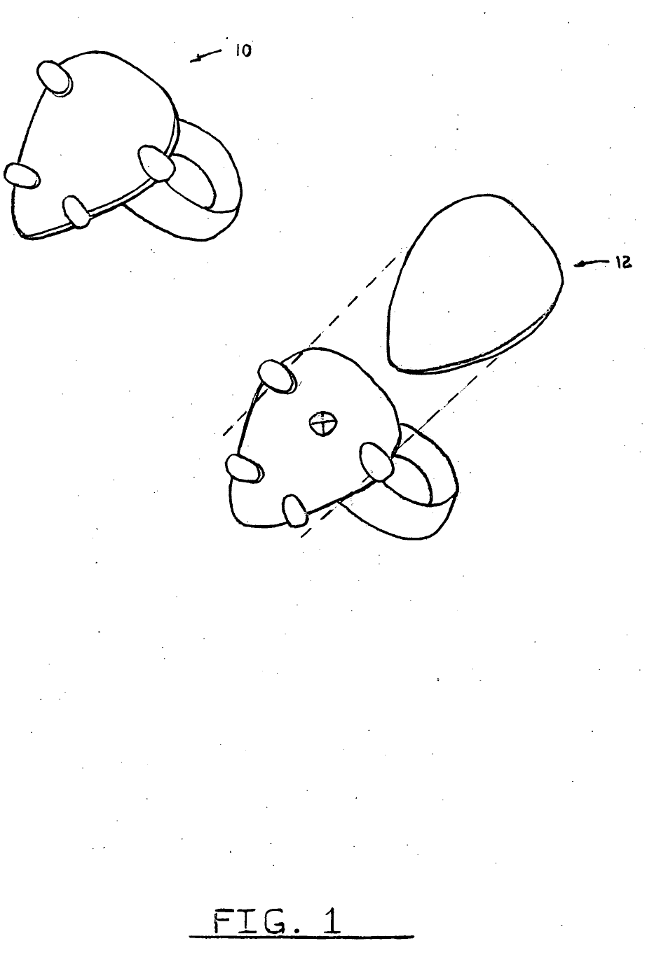

Referring to FIG. 1: A perspective view of a music article jewelry item 10 and adjacent to it a perspective of the same music article jewelry item as it relates to the removability of a plectrum commonly known as a guitar pick. The music article jewelry item with the plectrum commonly known as a guitar pick, removed 12. A plectrum commonly known as a guitar pick 12.

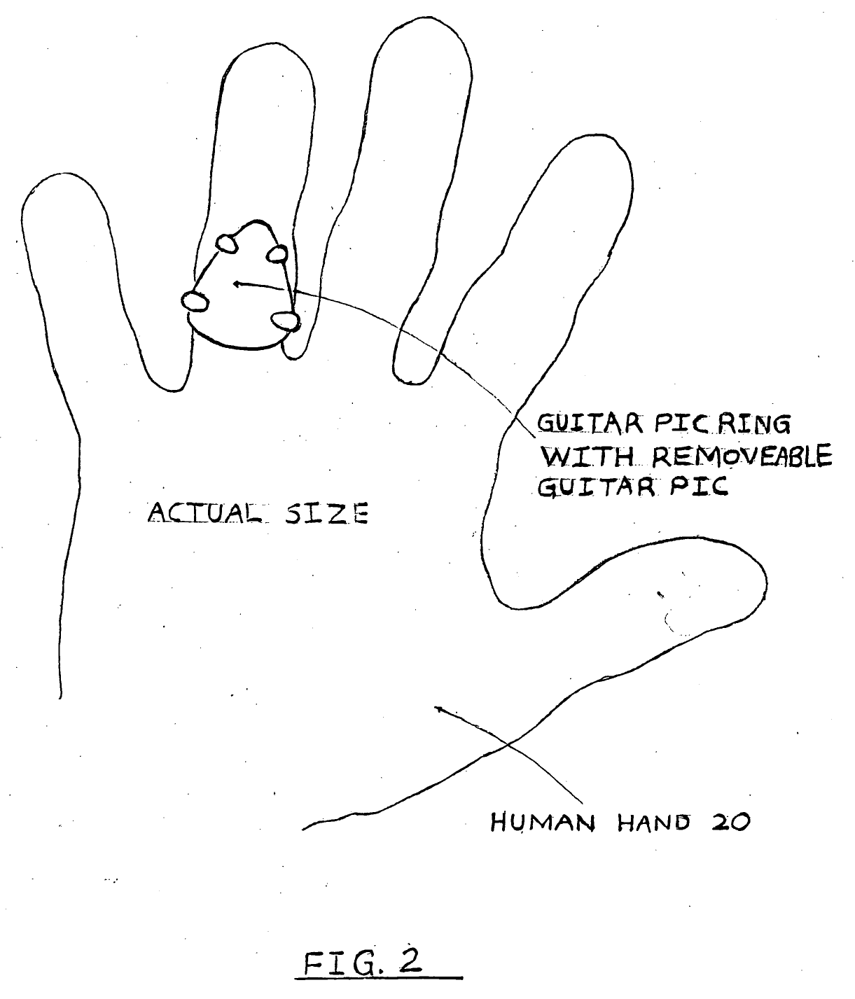

Referring to FIG. 2: A perspective view of the music article jewelry item as it relates to a musicians hand 20 illustrated to actual size.

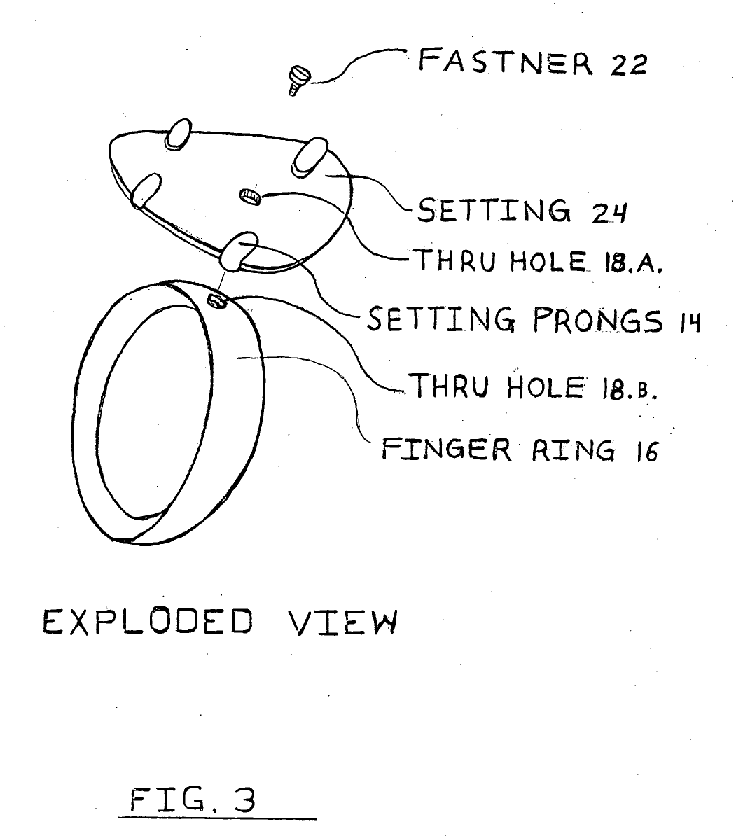

Referring to FIG. 3: A perspective exploded view illustrating the parts utilized for the invention such as a common finger ring 16, a setting 24 same size and shape of a plectrum commonly known as a guitar pick. Setting prongs 14 permanently attached to the setting designed to retain the guitar pick. The setting prongs attached to the setting are bent over toward the interior of the setting leaving an open space or commonly known as a gap. The gap which is one thirty second of an inch is sufficient to retain the guitar pick yet render the guitar pick removable.

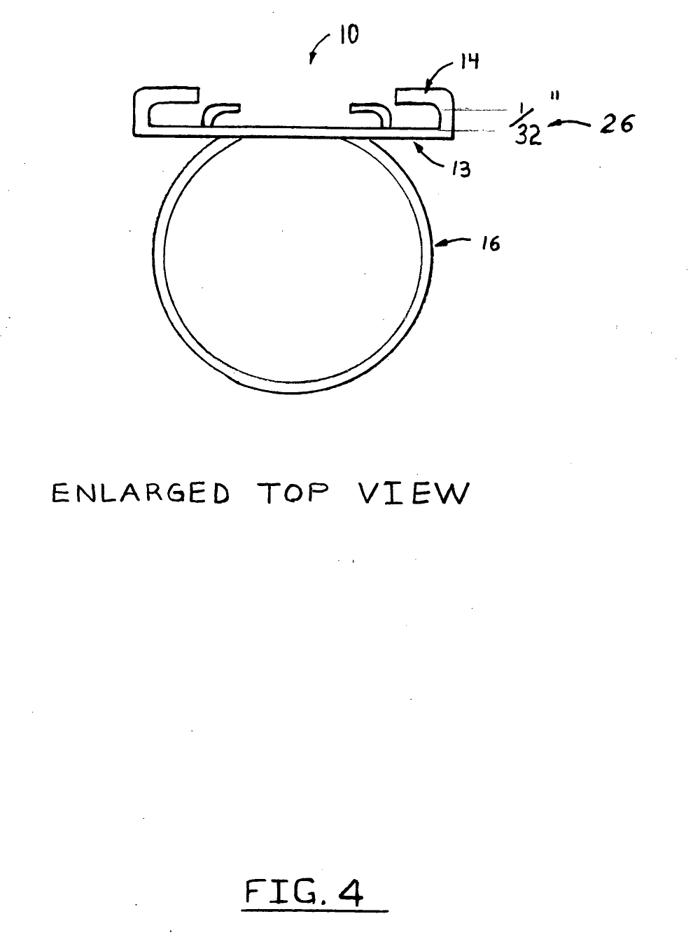

Referring to FIG. 4: An enlarged top view perspective illustrating the setting prongs 14. The finger ring 16 and the open space or gap between the setting prongs 14 and the face of the setting allowing the guitar pick to be retained yet removable.

I claim:

1. A Finger ring that holds a guitar pick that is removable.
